(19) United States
(12) Patent Application Publication
(10) Pub. No.: US 2010/0301993 A1
(43) Pub. Date: Dec. 2, 2010

(54) PATTERN BASED SECURITY AUTHORIZATION

(75) Inventors: Tamer E. Abuelsaad, Poughkeepsie, NY (US); Kelly Abuelsaad, Poughkeepsie, NY (US)

Correspondence Address: IBM Corporation, (OLP);c/o ORTIZ & LOPEZ, PLLC, P.O. Box 4484, Albuquerque, NM, 87196-4484, US

(73) Assignee: International Business Machines Corporation

(21) Appl. No.: 12/473,875

(22) Filed: May 28, 2009

(51) Int. Cl. G05B 19/00

(52) U.S. Cl. 340/5.2

(57) ABSTRACT

A method, system and computer-usable medium for authorizing access to a secure location are disclosed. Data indicative of security-related activities (e.g., badging in and/or out of a secure building) can be compiled and then mined to deduce a particular pattern of security-related activities. Access to the secure location can be then authorized, based on the particular pattern of security-related activities.

### TECHNICAL FIELD

Embodiments are generally related to data-processing systems and methods. Embodiments are additionally related to the field of computers and similar technologies, and in particular, to software utilized in this field. In addition, embodiments also relate to methods and systems for authorizing access to secure locations.

### BACKGROUND OF THE INVENTION

Security and authorization has become an integral facet of modern society. The ability to grant access to secure facilities is an important part of any effective security system. Many businesses or other organized meeting locales, such as conventions, trade shows, and parties, use security or visitor management systems to register individuals or visitors to a particular facility. The visitor management system or security system that is implemented at a particular facility may vary. Some systems involve the use of a personal computer and a camera. These approaches allow access control personnel to quickly and efficiently register visitors (or the visitors can register themselves), generate photo identification badges, and compiles a digital record of facility visitors.

One of the chief means of security and authorization thus involves the use of security or employee badges. For example, many businesses employ a badger located at the front entrance to a secure building, or some other type of security system to authorize or deny entry to the building. As the number of employees grows in a business or other organization, it may take the existing security system longer to authorize new employees or visitors into a particular building. The security system is forced to search through all the records of the employees to find an appropriate person. Such a cumbersome approach forces the security systems to attempt to collect as little information as possible from a particular person to grant that individual access.

### BRIEF SUMMARY

The following summary is provided to facilitate an understanding of some of the innovative features unique to the present invention and is not intended to be a full description. A full appreciation of the various aspects of the embodiments disclosed herein can be gained by taking the entire specification, claims, drawings, and abstract as a whole.

It is, therefore, one aspect of the present invention to provide for an improved data-processing method, system, and computer-usable medium.

It is another aspect of the present invention to provide for a method, system, and computer-usable medium for granting access to a secure location such as a building, secure area, etc.

It is a further aspect of the present invention to provide for a method, system, and computer-usable medium for authorizing access to a secure location based on a particular pattern of security-related activities such as, for example, badging in and out of a secure facility.

The aforementioned aspects and other objectives and advantages can now be achieved as described herein. A method, system, and computer-usable medium for authorizing access to a secure location are disclosed. Data indicative of security-related activities (e.g., badging in and/or out of a secure building) can be compiled and then mined to deduce a particular pattern of security-related activities. Access to the secure location can be then authorized based on the particular pattern of security-related activities. Additionally, a record of individuals with potential access to the secure location can be organized based on the particular pattern of security-related activities. A particular level of access to the secure location may also be granted to one or more individuals listed in the record based on the particular pattern of security-related activities. Access to the secure location can also be prioritized based on the particular pattern of security-related activities.

### BRIEF DESCRIPTION OF THE DRAWINGS

The accompanying figures, in which like reference numerals refer to identical or functionally-similar elements throughout the separate views and which are incorporated in and form a part of the specification, further illustrate the present invention and, together with the detailed description of the invention, serve to explain the principles of the present invention.

FIG. 1 illustrates a schematic diagram of a system for authorizing an individual access to a secure location, in accordance with an embodiment;

FIG. 2 illustrates a schematic view of a data-processing apparatus, which may be utilized to implement an embodiment of the present invention;

FIG. 3 illustrates a schematic view of a software system including an operating system, application software, and a user interface for carrying out the present invention;

FIG. 4 illustrates a graphical representation of a network of data processing systems, in which aspects of the present invention may be implemented;

FIG. 5 illustrates a high level flow chart of operations illustrating logical operational steps of a method for authorizing access to a secure facility based on a pattern of security-related activities, in accordance with an embodiment; and

FIG. 6 illustrates a high level flow chart of operations illustrating logical operational steps of a method for authorizing access to a secure facility based on a pattern of badging-related activities, in accordance with an embodiment.

### DETAILED DESCRIPTION

The particular values and configurations discussed in these non-limiting examples can be varied and are cited merely to illustrate at least one embodiment and are not intended to limit the scope of such embodiments.

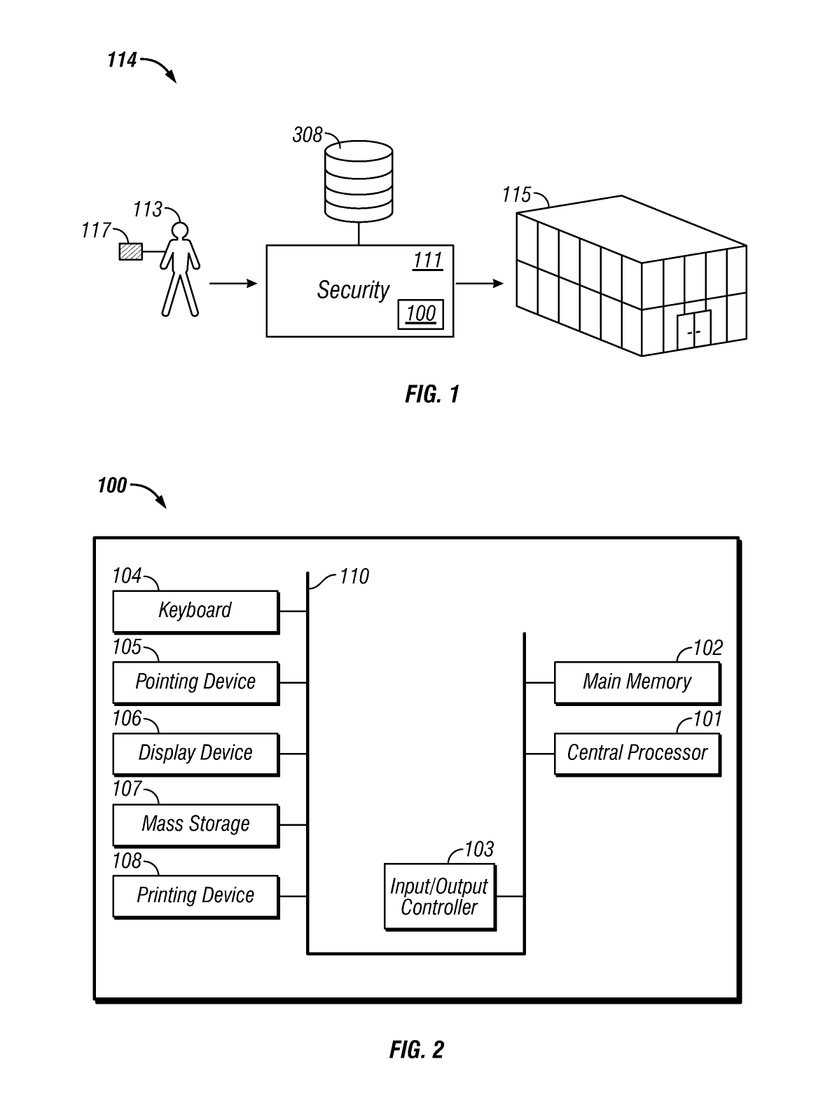

FIG. 1 illustrates a schematic diagram of a system 114 for authorizing an individual access to a secure location 115, in accordance with an embodiment. In the example depicted in FIG. 1, the secure location 115 may be, for example, an office building or a facility such as a warehouse, laboratory, or even a convention hall or a trade show hall. As indicated in the diagram of system 114, an individual 113 may desire access to the location 115. Such an individual 113 may be, for example, an employee of the company or organization that operates in the secure location 115 or the individual 113 may be a visitor to the secure location 115. It can be assumed that the individual 113 is associated with a badge 117 that identifies the particular individual and may also include additional authorization information. Information about the individual 113 (and other individuals) may be stored in a database 308. The individual 113 thus follows certain security-related activities, such as badging, in order to enter the secure location 115. These activities may take place, for example, on a regular or daily basis.

In one embodiment, the badge 117 may be, for example, a smart card, chip card, or an integrated circuit card (ICC). Such a badge can be implemented as a pocket-sized card with embedded integrated circuits, which can process data. This implies that badge 117 may be receiving input, which is processed—by way of the ICC applications—and delivered as an output. There are two broad categories of ICCs. Memory cards contain only non-volatile memory storage components and perhaps some specific security logic. Microprocessor cards contain volatile memory and microprocessor components. The card is made of plastic, generally PVC, but sometimes ABS. The card may embed a hologram to avoid counterfeiting. The use of smartcards for badge 117 is a form of strong security authentication for single sign-on within large companies and organizations. Note that in another embodiment, the badge 117 may simply be, instead of a smart card (or chip card or ICC), a badge equipped with a magnetic reader that contains electronic data associated with the individual 113.

Because most people that work in a business have a particular schedule that they must follow or a particular pattern can be deduced based on their security related activities, such as badging, a security module or system 111 can study this particular pattern and apply it to a sorting scheme. The security module or system 111 may include automatic machine oriented aspects such as the use of a data-processing apparatus, such as apparatus 100 depicted in FIG. 2. The security module or system 111 may also include a human-component such as a badging office. Thus, the time that the individual 113 arrives at such a badging office is a factor that is considered in associate with the disclosed embodiments.

The disclosed embodiments can implement a more efficient organizational scheme to be used by security systems to grant an individual, such as the individual 113, access to a protected area, such as the secure location 115. For the purpose of illustrating the idea behind the disclosed embodiments, one possible scenario involves badging into a building. It can be appreciated, however, that disclosed embodiments are not limited to badging systems, but apply to a broad spectrum of security systems. Reference to badging systems and badging activities herein are provided for generally illustrative purposes only.

In a badging scenario, for example, employees in a corporation usually have a pattern about their work schedules. For examples, Bob badges in at work at 9:05 AM Monday thru Wednesday and 9:10 AM Thursday thru Friday. This pattern can be deduced by mining the times at which an individual badges in. From the mined data, the system can see a pattern. Of course there are exceptions to every person's schedule, but the system 111 can be configured to ignore the exceptions and use the more common and repeated badging times. Based on the data collected, the security system 111 can reorganize its employee records and place Bob on the top of the list at 9:05 AM Monday thru Wednesday and 9:10 AM Thursday thru Friday, for example. However, for a more accurate result the system would need a built in tolerance, which could be on a seconds or minutes basis, depending on the needed level of sensitivity. With this approach, Bob will be able to badge in much quicker and avoid waiting for the badger associated with the security system 111 to sort through all the employee records to find his particular data. The sorting operations performed by the security system 111 can be accomplished by a secondary processor or at off peak hours.

Thus, data indicative of security-related activities (e.g., badging the individual 113 in and/or out of the secure building 115) can be compiled and then mined to deduce a particular pattern of security-related activities. Access to the secure location can be then authorized based on the particular pattern of security-related activities. Note that such data can be stored in the database 308, which is accessible by the data-processing apparatus 100.

FIGS. 2-4 are provided as exemplary diagrams of data processing environments in which embodiments of the present invention may be implemented. It should be appreciated that FIGS. 2-4 are only exemplary and are not intended to assert or imply any limitation with regard to the environments in which aspects or embodiments of the present invention may be implemented. Many modifications to the depicted environments may be made without departing from the spirit and scope of the present invention.

FIG. 2 illustrates a block diagram of the data-processing apparatus 100, which may be utilized to implement an embodiment of the present invention. Apparatus 100 generally includes a central processor 101, a main memory 102, an input/output controller 103, a keyboard 104, a pointing device 105 (e.g., mouse, track ball, pen device, or the like), a display device 106, and a mass storage 107 (e.g., hard disk). Additional input/output devices, such as a printing device 108, may be included in the data-processing apparatus 100 as desired. As illustrated, the various components of the data-processing apparatus 100 communicate through a system bus 110 or similar architecture. Apparatus 100 may be associated with a security system such as system 111 depicted in FIG. 1 or may be utilized by badging officers associated with system 111.

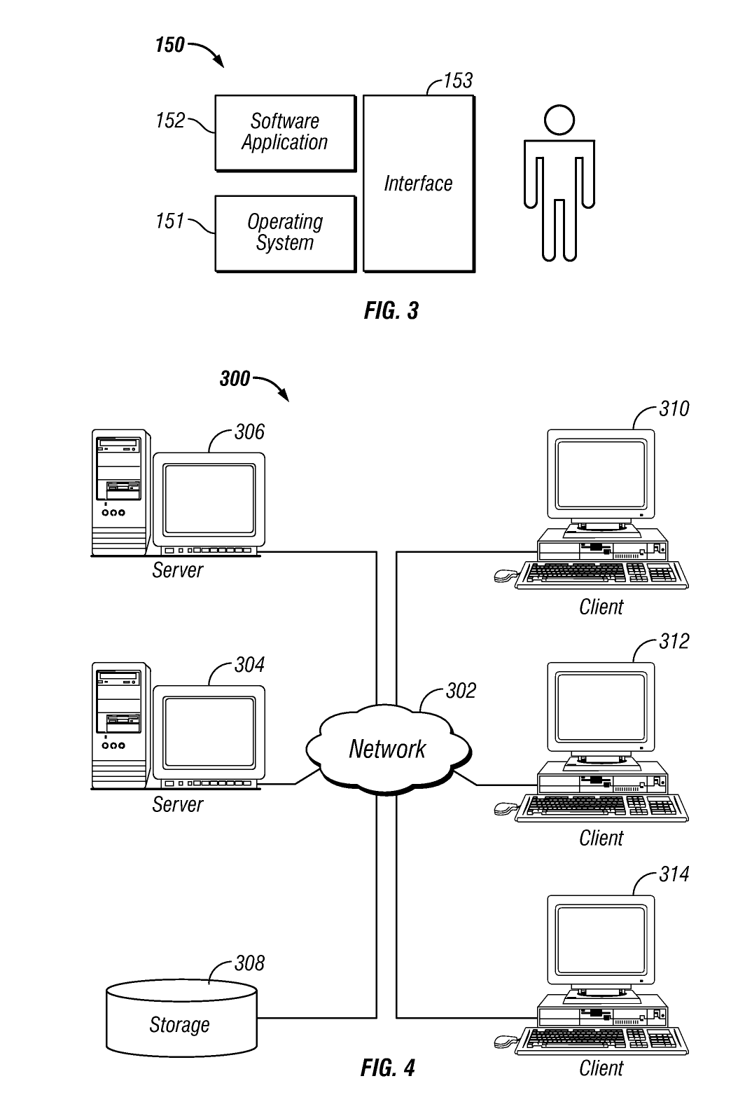

FIG. 3 illustrates a computer software system 150 provided for directing the operation of the data-processing apparatus 100. Software system 150, which is stored in system memory 102 and on disk memory 107, includes a kernel or operating system 151 and a shell or interface 153. One or more application programs, such as application software 152, may be “loaded” (i.e., transferred from storage 107 into memory 102) for execution by the data-processing apparatus 100. The data-processing apparatus 100 receives user commands and data through user interface 153; these inputs may then be acted upon by the data-processing apparatus 100 in accordance with instructions from operating module 151 and/or application module 152.

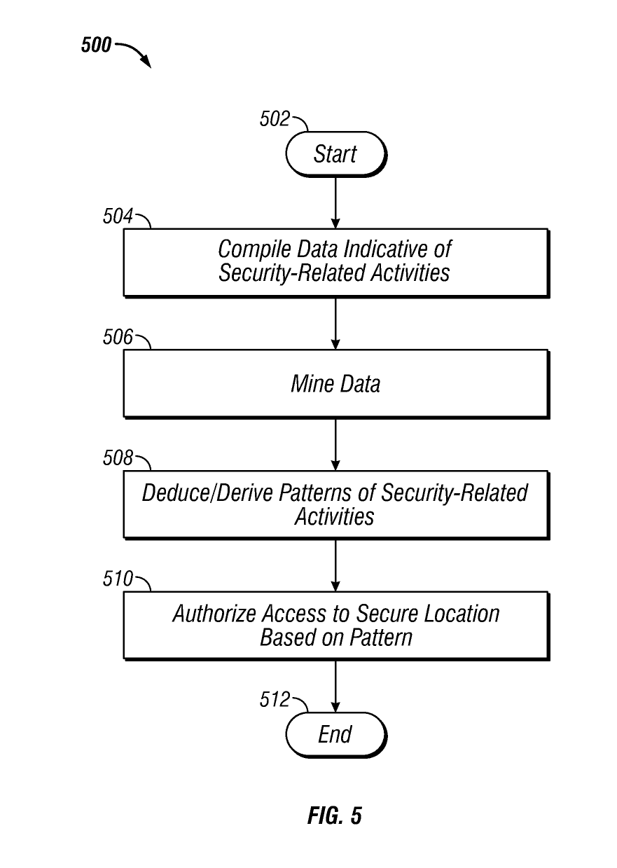

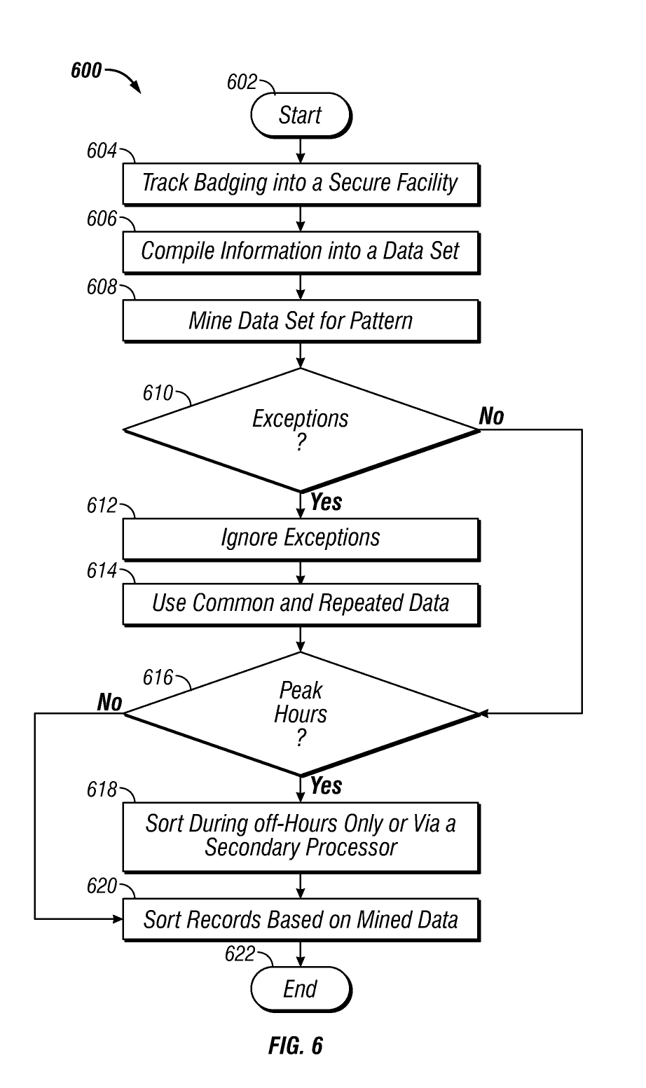

The interface 153 is preferably a graphical user interface (GUI). In one potential embodiment, operating system 151 and interface 153 can be implemented in the context of a “Windows” system. Application module 152, on the other hand, can include instructions, such as for directing the various operations described herein with respect to the various components and modules described herein such as, for example, the methods 500 and/or 600 respectively depicted in FIGS. 5-6.

FIG. 4 illustrates a graphical representation of a network of data processing systems in which aspects of the present invention may be implemented. Network data processing system 300 is a network of computers in which embodiments of the present invention may be implemented. Network data processing system 300 contains network 302, which is the medium used to provide communications links between various devices and computers connected together within network data processing apparatus 100. Network 302 may include connections such as wire, wireless communication links, or fiber optic cables.

In the depicted example, server 304 and server 306 connect to network 302 along with storage unit 308. In addition, clients 310, 312, and 314 connect to network 302. These clients 310, 312, and 314 may be, for example, personal computers or network computers. Data-processing apparatus 100 depicted in FIG. 2 can be, for example, a client such as client 310, 312, and/or 314. Alternatively, data-processing apparatus 100 can be implemented as a server such as servers 304 and/or 306, depending upon design considerations.

In the depicted example, server 304 provides data such as boot files, operating system images, and applications to clients 310, 312, and 314. Clients 310, 312, and 314 are clients to server 304 in this example. Network data processing system 300 may include additional servers, clients, and other devices not shown. Specifically, clients may connect to any member of networks of servers which provide equivalent content.

In the depicted example, network data processing system 300 is the Internet with network 302 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, government, educational, and other computer systems that route data and messages. Of course, network data processing system 300 also may be implemented as a number of different types of networks such as, for example, an intranet, a local area network (LAN), or a wide area network (WAN). FIG. 4 is intended as an example and not as an architectural limitation for different embodiments of the present invention.

The following description is presented with respect to embodiments of the present invention, which can be embodied in the context of a data-processing system such as data-processing apparatus 100, computer software system 150, data processing system 300, and network 302 depicted respectively FIGS. 2-4. The present invention, however, is not limited to any particular application or any particular environment. Instead, those skilled in the art will find that the system and methods of the present invention may be advantageously applied to a variety of system and application software, including database management systems, word processors, and the like. Moreover, the present invention may be embodied on a variety of different platforms, including Macintosh, UNIX, LINUX, and the like. Therefore, the description of the exemplary embodiments, which follows, is for purposes of illustration and not considered a limitation.

FIG. 5 illustrates a high level flow chart of operations illustrating logical operational steps of a method 500 for authorizing access to a secure facility or location based on a pattern of security-related activities, in accordance with an embodiment. As indicated at block 502, the process begins. Next, as depicted at block 504, an operation can be implemented to compile data indicative of one or more security related activities (e.g., badging activities, repeated badging activities, etc). Then, as illustrated at block 506, the data can be mined to then deduce or derive, as indicated at block 508, a particular pattern of security-related activities.

Note that as utilized herein, the term “data mining” in the context of data that can be “mined” refers generally to the process of extracting hidden patterns from data. Data mining is a tool to transform data into particular information. Data mining generally involves data processing using sophisticated data search capabilities and statistical algorithms to discover patterns and correlations in databases such as, for example, database 308. The data mining operation depicted at block 508, thus involves a process of analyzing data in order to determine patterns and their relationships. Following process of the operation depicted at block 508, an operation can be implemented, as indicated at block 510, for authorizing access to a secure location based on the particular pattern of security-related activities. The process can then terminate, as indicated at block 512.

FIG. 6 illustrates a high level flow chart of operations illustrating logical operational steps of a method 600 for authorizing access to a secure facility based on a pattern of badging-related activities, in accordance with an embodiment. FIG. 6 illustrates an alternative methodology, which can serve to implement a number of varying security-related activities. The methodology depicted in FIG. 6 is focused more particularly on badging-related activities and thus represents a variation to the methodology depicted in FIG. 5. Thus, as indicated at block 602, the process begins. Next, as depicted at block 604, information related to badging by an individual into a secure facility can be tracked. Such information may be, for example, the times that the individual badges into the facility over a period of days or weeks. Thereafter, as described at block 606, the information can be compiled into a data set. Next, as indicated at block 608, the data set can be mined to deduce a particular pattern of badging activities (e.g., time of day the individual badges into the building). Next, as depicted at block 610, a test can be performed if there are any exceptions to the identified pattern. If so, then as depicted at block 612, the exceptions are ignored and use common and repeated badging activities associated with the individual for continued processing, as indicated at block 614. Thereafter, as illustrated at block 616 a test may be performed to determine if the time of sorting data coincides with peak hours associated with a particular business or organization. Assuming that this is the case (i.e., peak hours current), then sorting operations can be delayed to off hours only or currently via a secondary processor, as depicted at block 618. Thereafter, as indicated at block 620, the actual sorting operation can be implemented to sort through, for example, employee records, prioritize badging, and authorization levels. The process can then terminate, as illustrated at block 622.

Note that in some embodiments, the various logical operational steps of methods 500 and 600 may be implemented as instructions in the context of a computer-useable medium that contains a program product. Programs defining functions on the present invention can be delivered to a data storage system or a computer system via a variety of signal-bearing media, which include, without limitation, non-writable storage media (e.g., CD-ROM), writable storage media (e.g., hard disk drive, read/write CD ROM, optical media), system memory such as, but not limited to, Random Access Memory (RAM), and communication media such as computer and telephone networks including Ethernet, the Internet, wireless networks, and like network systems. It should be understood therefore, that such signal-bearing media when carrying or encoding computer readable instructions of methods 500 and 600 that direct method functions of the present invention, may represent alternative embodiments of the present invention. Further, it is understood that the present invention may be implemented by a system having components or modules in the form of hardware, software, or a combination of software and hardware as described herein or their equivalent. Thus, the method described herein can be deployed as process software in the context of a computer system or data-processing apparatus and/or system as that depicted in FIGS. 1-4.

While the present invention has been particularly shown and described with reference to embodiments or alternative embodiments, it will be understood by those skilled in the art that various changes in form and detail may be made therein without departing from the spirit and scope of the invention. Furthermore, as used in the specification and the appended claims, the term “computer” or “system” or “computer system” or “computing device” or “data processing apparatus” includes any data processing system including, but not limited to, personal computers, servers, workstations, network computers, main frame computers, routers, switches, telephones, and any other system capable of processing, transmitting, receiving, capturing and/or storing data.

It will be appreciated that variations of the above-disclosed and other features and functions, or alternatives thereof, may be desirably combined into many other different systems or applications. Also, that various presently unforeseen or unanticipated alternatives, modifications, variations, or improvements therein may be subsequently made by those skilled in the art which are also intended to be encompassed by the following claims.

What is claimed is:

1. A method for authorizing access to a secure location, said method comprising:
compiling data indicative of a plurality of security-related activities;
mining said data indicative of said plurality of security-related activities to deduce a particular pattern of security-related activities; and
authorizing access to a secure location, based on said particular pattern of security-related activities.

2. The method of claim 1 further comprising organizing a record of individuals with potential access to said secure location, based on said particular pattern of security-related activities.

3. The method of claim 2 further comprising granting a particular level of access to said secure location to at least one individual listed in said record, based on said particular pattern of security-related activities.

4. The method of claim 2 further comprising prioritizing access to said secure location to individuals listed in said record, based on said particular pattern of security-related activities.

5. The method of 1 further comprising storing said data indicative of said plurality of security-related activities in a database.

6. The method of claim 1 wherein at least one security-related activity among said plurality of security-related activities comprises a badging activity necessary to authorize access to said secure location.

7. The method of claim 1 wherein said particular pattern of security-related activities comprises particular instances respectively associated with said plurality of security-related activities.

8. A system for authorizing access to a secure location, said system comprising:
a processor;
a data bus coupled to said processor; and
a computer-usable medium embodying computer code, said computer-usable medium being coupled to said data bus, said computer program code comprising instructions executable by said processor and configured for:
compiling data indicative of a plurality of security-related activities;
mining said data indicative of said plurality of security-related activities to deduce a particular pattern of security-related activities; and
authorizing access to a secure location, based on said particular pattern of security-related activities.

9. The system of claim 8 wherein said instructions are further configured for organizing a record of individuals with potential access to said secure location, based on said particular pattern of security-related activities.

10. The system of claim 9 wherein said instructions are further configured for granting a particular level of access to said secure location to at least one individual listed in said record, based on said particular pattern of security-related activities.

11. The system of claim 9 wherein said instructions are further configured for prioritizing access to said secure location to individuals listed in said record, based on said particular pattern of security-related activities.

12. The system of 8 wherein said instructions are further configured for storing said data indicative of said plurality of security-related activities in a database.

13. The system of claim 8 wherein at least one security-related activity among said plurality of security-related activities comprises a badging activity necessary to authorize access to said secure location.

14. The system of claim 8 wherein said particular pattern of security-related activities comprises particular instances respectively associated with said plurality of security-related activities.

15. A computer-usable for authorizing access to a secure location, said computer-usable medium embodying computer program code, said computer program code comprising computer executable instructions configured for:
compiling data indicative of a plurality of security-related activities;
mining said data indicative of said plurality of security-related activities to deduce a particular pattern of security-related activities; and
authorizing access to a secure location, based on said particular pattern of security-related activities.

16. The computer usable medium of claim 15 wherein said embodied computer program code further comprises computer executable instructions configured for organizing a record of individuals with potential access to said secure location, based on said particular pattern of security-related activities.

17. The computer usable medium of claim 16 wherein said embodied computer program code further comprises computer executable instructions configured for granting a particular level of access to said secure location to at least one individual listed in said record, based on said particular pattern of security-related activities.

18. The computer usable medium of claim 16 wherein said embodied computer program code further comprises computer executable instructions configured for prioritizing access to said secure location to individuals listed in said record, based on said particular pattern of security-related activities.

19. The computer usable medium of claim 15 wherein said embodied computer program code further comprises computer executable instructions configured for further comprising storing said data indicative of said plurality of security-related activities in a database.

20. The computer usable medium of claim 15 wherein said particular pattern of security-related activities comprises particular instances respectively associated with said plurality of security-related activities.
